(19) United States
(12) Patent Application Publication
(10) Pub. No.: US 2014/0217276 A1
(43) Pub. Date: Aug. 7, 2014

(54) Sequential Low/High-Resolution Library Search

(71) Applicant: Agilent Technologies, Inc., Loveland, CO (US)

(72) Inventors: George E. Yefchak, Fremont, CA (US); Carl A. Myerholtz, San Jose, CA (US)

(73) Assignee: Agilent Technologies, Inc., Loveland, CO (US)

(21) Appl. No.: 14/117,460

(22) PCT Filed: May 24, 2011
(86) PCT No.: PCT/US11/37784

§ 371 Date: Nov. 13, 2013

(51) Int. Cl. H01J 49/00; H01J 49/02

(52) U.S. Cl. CPC H01J 49/0036; H01J 49/02
USPC 250/282; 250/281

(57) ABSTRACT

Provided herein are systems and method for using unit mass library searches for sample identification in accurate mass spectrometry. In general, the systems and methods described herein: (a) obtain an accurate mass spectrum of a sample; (b) calculate a unit mass spectrum based on the accurate mass spectrum; and (c) conduct a unit mass library search, based on the calculated unit masses, to obtain at least one candidate species to thereby identify the sample. The systems and methods may further: (d) calculate exact masses for each of a plurality of candidate species; and (e) eliminate candidate species due to ions that are outside a mass error window. The mass error window may be less than 500 ppm. The system and methods presented may be used in, for example, gas chromatrography mass spectrum and/or liquid chromatography mass spectrometry systems.

### SUMMARY

Provided herein are systems and method for using unit mass library searches for sample identification in accurate mass spectrometry. In general, the systems and methods described herein: (a) obtain an accurate mass spectrum of a sample; (b) calculate a unit mass spectrum based on the accurate mass spectrum; and (c) conduct a unit mass library search, based on the calculated unit mass spectrum, to obtain at least one candidate species to thereby identify the sample. The systems and methods may further: (d) calculate the exact mass for each of a plurality of candidate species; and (e) eliminate candidate species that are outside a mass error window. The mass error window may be less than 500 parts-per-million (ppm). The system and methods presented may be used in, for example, gas chromatography mass spectrometry and/or liquid chromatography mass spectrometry.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the claimed systems and methods.

FIG. 1 is a flow chart illustrating an embodiment of the present invention.

FIG. 2 shows two example compounds and their electron ionization mass spectra to illustrate an aspect of the present invention.

FIG. 3 is a schematic illustration of a computer system for carrying out the methods described herein.

### DETAILED DESCRIPTION

The present invention generally relates to mass spectral analysis. More specifically, the present invention relates to systems and methods for conducting mass spectrometer (MS) library searches.

A mass spectrum is a plot of ion abundance versus ion mass or mass-to-charge ratio, typically corresponding to a chemical species of interest. The pattern of ion abundances, or a subset of them, can be compared with those previous recorded in a mass spectral “library” to identify or confirm the presence of a particular chemical substance. Large libraries of spectra already exist, for example the National Institute of Standards and Technology (NIST), Environmental Protection Agency (EPA), and National Institute of Health (NIH) mass spectral libraries contains spectra for over 190,000 chemical compounds obtained using mass spectrometers incorporating conventional electron ionization sources.

Typical commercial or public libraries such as the NIST library mentioned above contain mass spectra recorded with “unit” mass resolution. That is, each mass is represented by an integer number of atomic mass units (e.g., 1 u for hydrogen, 14 u for nitrogen, etc.). State-of-the-art high-resolution mass spectrometers, however, can measure accurate masses to within 1 part-per-million (ppm) accuracy or better (e.g., 1.007276 u for H, 14.00253 u for N). The small difference between the actual “exact mass” and the integer value is called the mass defect. Accurate mass spectrum can be used along with the known mass defects for each element to generate a list of possible molecular formulas. With enough mass accuracy, sometimes the list can be narrowed down to a single formula. For example, when considering only compounds with integer molecular weight of 118 u containing carbon, hydrogen, oxygen, and nitrogen, no two species have exact masses which differ by less than 34 ppm, so for example a measured mass of 118.10 u can only correspond to the formula C₄H₁₂N₃O.

Accurate-mass data has not typically been used for library searching in unit mass libraries, however, for at least two reasons. First, the most commercially successful high-resolution instruments are typically used with soft-ionization sources such as electrospray rather than electron ionization. Spectra produced in this way show little fragmentation and thus do not provide a complex pattern which would be well suited for spectral matching algorithms. Secondly, the accurate mass spectrum of the parent ion (or a related species such as the (M+H)⁺ adduct) allows for formula determination based substantially on mass defect information, obviating the need for library searching. But highly accurate masses can be obtained for traditional “library-searchable” species if an electron ionization source is used. Provided herein is a method for performing a unit mass library search and enhancing the results of this search using accurate-mass data.

Spectral library search algorithms generally include, at some basic level, a comparison between the measured spectrum and spectra stored in the library. In the newly proposed method, a measured high-resolution, accurate-mass spectrum would be first searched against a low-resolution, unit mass spectral library. The measured high-resolution, accurate-mass spectrum may be transformed into a unit-mass-resolution spectrum simply by adjusting each measured mass to the corresponding integer value (usually the nearest integer).

The adjusted spectrum would be subjected to a unit mass library search in a typical fashion, resulting in matches (a “hit list”) representing proposed candidate species. Once this list is obtained, exact masses would be calculated for the molecular ions, and possibility isotope clusters, corresponding to each species. (In addition, exact masses for proposed substructures could be calculated as well, given a suitable algorithm for fragment ion generation). These exact masses would be compared to the measured high-resolution, accurate molecular mass (and perhaps fragment ion masses) to narrow down the list of possible candidate species.

Note that spectral libraries such as the NIST library include the molecular formula of each measured species, so it would be possible to calculate the exact mass for at least the molecular in the database ahead of time. Note also that the distribution of isotope ions (an isotope cluster) for the molecular ion can also be readily calculated from the natural abundance ratios of each element. For example, the ¹³C isotope is known to be present at approximately 1.1% of the level of the ¹²C isotope. Thus the mass spectrum for an organic compound containing n carbon atoms typically displays a so-called “M+1” ion whose abundance is approximately 0.011×n relative to the abundance of the molecular ion. The pattern of abundances in the isotope cluster can often be useful in identifying the molecular formula. Comparison of the expected exact masses and expected isotope ratios in the isotope cluster to those obtained by accurate mass spectrum can provide additionally help in narrowing down the list of candidate species.

The following detailed description of the figures refers to the accompanying drawings that illustrate exemplary embodiments. Other embodiments are possible. Modifications may be made to the embodiments described herein without departing from the spirit and scope of the present invention. Therefore, the following detailed description is not meant to be limiting.

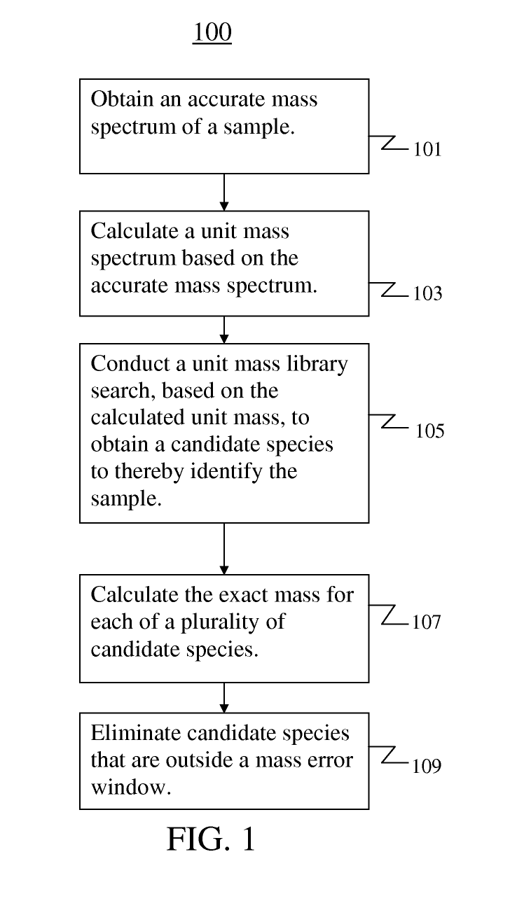

For example, FIG. 1 is a flow chart illustrating an embodiment of the present invention. The method of FIG. 1 may be employed for using unit mass library searches for sample identification in accurate mass spectrometry. In step 101, an accurate mass spectrum of a sample is obtained. In step 103, a unit mass spectrum is calculated based on the accurate mass spectrum. In step 105, a unit mass library search is conducted, based on the calculated unit mass spectrum, to obtain at least one candidate species to thereby identify the sample. As such, a unit mass library can be used in conjunction with an accurate mass measurement system. If the library search results in a “hit list” of more than one candidate species, the systems and methods may: calculate the exact mass for one or more ions in the expected mass spectrum for each of the plurality of candidate species, step 107; and eliminate candidate species based on observed mass spectrum that are outside a mass error window, step 109. The mass error window may be less than 500 ppm, less than 250 ppm, less than 50 ppm, less than 35 ppm, less than 10 ppm, or even less than 1 ppm. The system and methods presented may be used in, for example, gas chromatography mass spectrometry and/or liquid chromatography mass spectrometry.

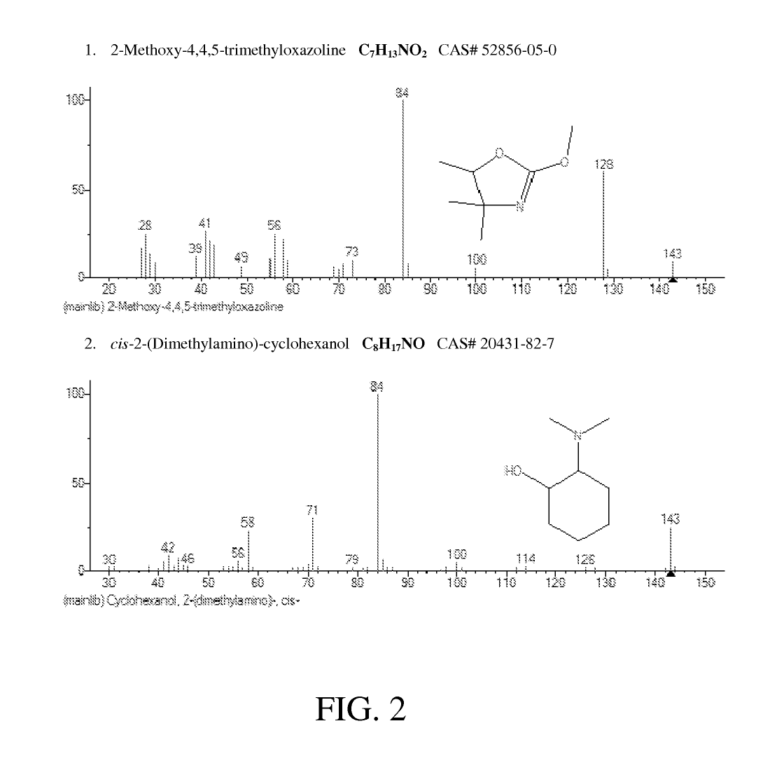

FIG. 2 shows two example compounds and their electron ionization mass spectra to illustrate an aspect of the present invention. Spectra (1) and (2) share a number of significant similarities, including the molecular ion at m/z 143 (i.e., unit/integer mass of 143 u), the base peak (largest peak) at m/z 84, and significant ions at m/z 58 and 100. These similarities could be significant enough to cause a library matching system to report both species as “hits,” or candidate species. There are also some differences in the two spectra, particularly the ion at m/z 128 which is only present in spectrum (1). These differences will be ignored for purposes of this illustration.

If high-resolution (i.e., accurate mass) mass spectral data is available, the accurate mass data can be used to distinguish these two compounds. Since the library (e.g., the NIST mass spectral library) database contains the names and, more importantly, the molecular formulas for each included compound, the expected molecular ion masses can be readily calculated: e.g., C₇H₁₃NO₂=143.09408 u; C₈H₁₇NO=143.13047 u.

Note that for singly charged ions, the molecular ion mass is equal to the (monoisotopic) molecular weight minus the weight of one electron, ˜0.00055 u.

The masses of these compounds differ by approximately 250 ppm and could be easily distinguished by establishing a mass error window to test the high-resolution, accurate mass measurement.

Consider also the tallest (“base”) peak at m/z 84. Chemical formulas for fragment ion species are not readily available from information in the spectral library. However, it can be illustrated that the m/z 84 ion corresponding to the first and second compounds have the formulas and masses: C₆H₄NO=84.04439; C₅H₁₀N=84.08078

Again, these masses differ by a significant amount, approximately 430 ppm, and could be easily distinguished by high-resolution, i.e., accurate mass data. If software capable of predicting the ionization pathways or other means is implemented so that the fragment ion formulas above could be determined in an automated fashion, the use of high-resolution mass spectral data would again be beneficial. This could be especially important if, for example, the molecular ion were not observed.

The presented methods may also be included within a more complex process searching and testing process wherein a number of factors used within a library search algorithm are combined into an overall score for each hit. The results of the high-resolution mass spectral step may then be incorporated into this overall score.

The presented methods, or any part(s) or function(s) thereof, may be implemented using hardware, software, or a combination thereof, and may be implemented in one or more computer systems or other processing systems. Further, the presented methods may be implemented with the use of one or more mass spectrometers such as: accurate mass spectrometers, TOFs, traps, quadrupole, Orbitrap-type, FT, or magnetic sector instruments. Where the presented methods refer to manipulations that are commonly associated with mental operations, such as, for example, providing, determining, obtaining, calculating, conducting, receiving, or performing, no such capability of a human operator is necessary. In other words, any and all of the operations described herein may be machine operations. Useful machines for performing the operation of the methods include general purpose digital computers or similar devices.

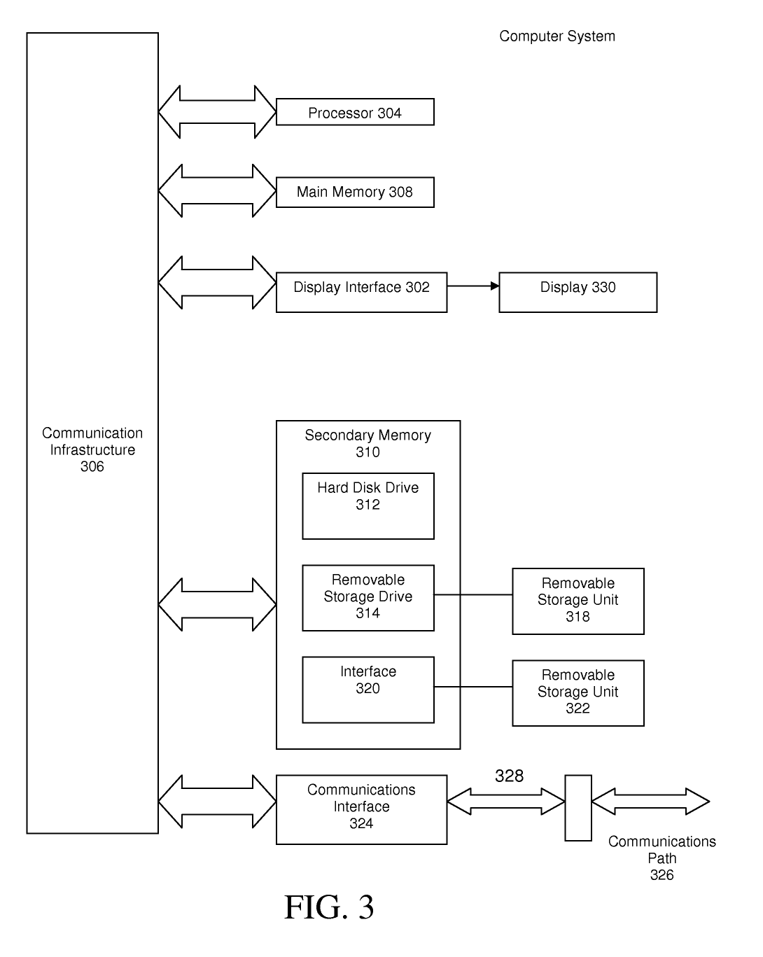

In fact, in one embodiment, the invention is directed toward one or more computer systems capable of carrying out the functionality described herein. An example of a computer system 300 is shown in FIG. 3. Computer system 300 includes one or more processors, such as processor 304. The processor 304 is connected to a communication infrastructure 306 (e.g., a communications bus, cross-over bar, or network). Computer system 300 can include a display interface 302 that forwards graphics, text, and other data from the communication infrastructure 306 (or from a frame buffer not shown) for display on a local or remote display unit 330.

Computer system 300 also includes a main memory 308, such as random access memory (RAM), and may also include a secondary memory 310. The secondary memory 310 may include, for example, a hard disk drive 312 and/or a removable storage drive 314, representing a floppy disk drive, a magnetic tape drive, an optical disk drive, flash memory device, etc. The removable storage drive 314 reads from and/or writes to a removable storage unit 318 in a well-known manner. Removable storage unit 318 represents a floppy disk, magnetic tape, optical disk, flash memory device, etc., which is read by and written to by removable storage drive 314. As will be appreciated, the removable storage unit 318 includes a computer usable storage medium having stored therein computer software and/or data.

In alternative embodiments, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket, and other removable storage units 322 and interfaces 320, which allow software and data to be transferred from the removable storage unit 322 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals 328 which may be electronic, electromagnetic, optical or other signals capable of being received by communications interface 324. These signals 328 are provided to communications interface 324 via a communications path (e.g., channel) 326. This channel 326 carries signals 328 and may be implemented using wire or cable, fiber optics, a telephone line, a cellular link, a radio frequency (RF) link, a wireless communication link, and other communications channels.

In this document, the terms “computer-readable storage medium,” “computer program medium,” and “computer usable medium” are used to generally refer to media such as removable storage drive 314, removable storage units 318, 322, data transmitted via communications interface 324, and/or a hard disk installed in hard disk drive 312. These computer program products provide software to computer system 300. Embodiments of the present invention are directed to such computer program products.

Computer programs (also referred to as computer control logic) are stored in main memory 308 and/or secondary memory 310. Computer programs may also be received via communications interface 324. Such computer programs, when executed, enable the computer system 300 to perform the features of the present invention, as discussed herein. In particular, the computer programs, when executed, enable the processor 304 to perform the features of the presented methods. Accordingly, such computer programs represent controllers of the computer system 300. Where appropriate, the processor 304, associated components, and equivalent systems and sub-systems thus serve as “means for” performing selected operations and functions.

In an embodiment where the invention is implemented using software, the software may be stored in a computer program product and loaded into computer system 300 using removable storage drive 314, interface 320, hard drive 312, or communications interface 324. The control logic (software), when executed by the processor 304, causes the processor 304 to perform the functions and methods described herein.

In another embodiment, the methods are implemented primarily in hardware using, for example, hardware components such as application specific integrated circuits (ASICs). Implementation of the hardware state machine so as to perform the functions and methods described herein will be apparent to persons skilled in the relevant art(s). In yet another embodiment, the methods are implemented using a combination of both hardware and software.

Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

For example, in one embodiment, there is provided a computer-readable storage medium for using unit mass library searches for sample identification in accurate mass spectrometry, comprising instructions executable by at least one processing device that, when executed, cause the processing device to: (a) obtain an accurate mass spectrum of a sample; (b) calculate a unit mass spectrum based on the accurate mass spectrum; and (c) conduct a unit mass library search, based on the calculated unit masses, to obtain a candidate species to thereby identify the sample.

The computer-readable storage medium may further include instructions that, when executed, cause the processing device to: (1) obtain a plurality of candidate species; (2) calculate the exact mass for each of the plurality of candidate species; (3) eliminate candidates species due to one or more ions that are outside a mass error window or windows; and/or (4) incorporate the difference between the obtained accurate mass spectrum and the exact masses for each of the plurality of candidate species into an overall score of the library search.

### CONCLUSION

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

Unless defined otherwise, all technical and scientific terms used herein have the same meaning as commonly understood by one of ordinary skill in the art to which this invention belongs.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments are specifically embraced by the present invention and are disclosed herein just as if each and every combination was individually and explicitly disclosed, to the extent that such combinations embrace operable processes and/or devices/systems/kits.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

1. A method of using unit mass library searches for sample identification in accurate mass spectrometry, the method comprising:
(a) obtaining an accurate mass spectrum of a sample;
(b) calculating a unit mass spectrum based on the accurate mass spectrum; and
(c) conducting a unit mass library search, based on the calculated unit masses, to obtain a candidate species to thereby identify the sample.

2. The method of claim 1, wherein step (c) further comprises obtaining a plurality of candidate species.

3. The method of claim 2, further comprising:
(d) calculating exact masses for ions from the spectra for each of the plurality of candidate species.

4. The method of claim 3, further comprising:
(e) eliminating candidate species with ions that are outside a mass error window.

5. The method of claim 4, wherein the error window is less than 500 ppm.

6. The method of claim 4, wherein the error window is less than 250 ppm.

7. The method of claim 4, wherein the error window is less than 50 ppm.

8. The method of claim 4, any of claims 4, further comprising:
(f) incorporating the difference between the obtained accurate mass spectrum and the exact mass for each of the plurality of candidate species into an overall score of the library search.

9. A computer-readable storage medium for using unit mass library searches for sample identification in accurate mass spectrometry, comprising:
instructions executable by at least one processing device that, when executed, cause the processing device to
(a) obtain an accurate mass spectrum of a sample;
(b) calculate a unit mass spectrum based on the accurate mass spectrum; and
(c) conduct a unit mass library search, based on the calculated unit masses, to obtain a candidate species to thereby identify the sample.

10. The computer-readable storage medium of claim 9, further comprising instructions that, when executed, cause the processing device to obtain a plurality of candidate species.

11. The computer-readable storage medium of claim 10, further comprising instructions that, when executed, cause the processing device to calculate the exact mass for each of the plurality of candidate species.

12. The computer-readable storage medium of claim 10, further comprising instructions that, when executed, cause the processing device to eliminate candidate species based on ions that are outside a mass error window.

13. The computer-readable storage medium of claim 12, wherein the error window is less than 500 ppm.

14. The computer-readable storage medium of claim 12, wherein the error window is less than 250 ppm.

15. The computer-readable storage medium of claim 12, wherein the error window is less than 50 ppm.

16. The computer-readable storage medium of claim 12, further comprising instructions that, when executed, cause the processing device to incorporate the difference between the obtained accurate mass spectrum and the exact mass for each of the plurality of candidate species into an overall score of the library search.

17. A gas chromatography mass spectrometer, comprising the computer-readable storage medium claim 9.

18. A liquid chromatography mass spectrometer, comprising the computer-readable storage medium of claim 9.
